(19) United States
(12) Patent Application Publication
(10) Pub. No.: US 2025/0347165 A1
(43) Pub. Date: Nov. 13, 2025

(54) HOUSEHOLD APPLIANCE WITH MOTORIZED CLOSING ELEMENT

(71) Applicant: Miele & Cie. KG, Guetersloh (DE)

(72) Inventor: Dennis WITHOT, Warendorf (DE)

(21) Appl. No.: 19/201,504

(22) Filed: May 7, 2025

(30) Foreign Application Priority Data
May 7, 2024 (DE) 102024112751.1

(51) Int. Cl. E05F 15/616; F24C 15/02

(52) U.S. Cl. CPC E05F 15/616; F24C 15/023; E05Y 2201/216; E05Y 2900/308

(57) ABSTRACT

A household appliance with an interior space to receive at least one object to be treated through an access opening, having a closing element to close and unblock the access opening from the front, and having a motor designed to move the closing element back and forth between a closed position and an open position. The motor is fixedly connected to a clutch disc by a motor shaft in order to rotatably drive the clutch disc, wherein the clutch disc is connected to the closing element in a force-transmitting manner by means of a clutch pin. The clutch disc has a clutch-side guide contour that movably receives a first end of the clutch pin, wherein the clutch-side guide contour of the clutch disc has a manual operation guide and a motor operation guide. The motor operation guide is formed by one end of the manual operation guide.

### RELATED APPLICATIONS

This application claims priority to German Patent Application No. 10 2024 112 751.1, filed May 7, 2024, the entire contents of which is incorporated herein by reference in its entirety.

### FIELD

The present disclosure relates to a household appliance with a motorized closing element.

### BACKGROUND

Cooking appliances are known which have a stationary, i.e., fixed, cooking chamber formed by the cooking appliance and in which the food to be cooked can be arranged in or on a cooking vessel and cooked with the cooking chamber of the cooking appliance closed. Such a cooking appliance can be, for example, an oven, a steamer, a combination appliance consisting of an oven with a steamer, and the like. Such cooking appliances having a fixed cooking chamber usually have an installation height of approximately 45 cm along the vertical axis, at least in Germany, although ovens with an installation height of approximately 60 cm are also common.

Such cooking appliances having a fixed cooking chamber have in common that they have an exterior housing which essentially encloses the cooking appliance on the outside and protects its individual components and elements and makes them easier to handle together. An interior space is formed inside the cooking appliance, which is the cooking chamber and which is substantially enclosed by an inner housing as the interior housing, also known as a cooking chamber muffle or muffle. Between the interior housing and the exterior housing a housing space is formed as an intermediate space in which functional elements of the cooking appliance, such as, for example, a control or control unit, an electrical power supply and other components that serve the intended use of the cooking appliance can be arranged. In depth from the front, i.e., viewed from the perspective of a user, the exterior housing or a panel in the form of a furniture material or in the form of a control panel and the like, together with the interior housing, closes off the housing space, so that the housing space is not accessible to the user.

The interior space of the cooking appliance has a through-opening in the depth towards the front as an access opening, through which the interior of the cooking appliance is accessible to the user to insert cooking vessels into the interior of the cooking appliance, its cooking chamber, and to arrange them there, as well as to remove cooking vessels from the interior of the cooking appliance after the food has been cooked and to remove said cooking vessels from there. The access opening can be opened by the user by means of a closing element, for example in the form of a laterally pivotable door, a downwardly pivotable door and the like, to be able to access the interior space of the cooking appliance, as previously described, or to close the interior of the cooking appliance and carry out the cooking operation or process. Such a closing element can be designed to be solid or have a viewing window to allow the user to see into the closed interior space of the cooking appliance.

Such cooking appliances with a fixed cooking chamber are usually designed as built-in appliances or as built-in kitchen appliances to be arranged with their exterior housing in a space-saving manner and at a height that is easily accessible for the user along the vertical axis in kitchen furniture, such as in built-in kitchen cabinets, and to be arranged with their closing element, if necessary additionally with their panel, see above, facing to the front towards the user, flush with the surfaces of the other cooking appliances, drawers, doors and the like of the kitchen furniture, which can improve the visual appearance for the user. However, such cooking appliances can also be designed as individual, separate appliances that can be set up and operated, in particular, on a work surface of a kitchen unit. This can simplify flexibility of use as well as purchase and disposal.

In such cooking appliances, the closing element, such as a laterally pivotable door or a downwardly pivotable door, is operated manually by a person as the user, i.e., a handle, grip or the like is grasped with the fingers of one hand and then moved or pivoted back and forth between the fully opened state, in order to be able to access the cooking chamber as easily as possible, and the fully closed state, in order to carry out the cooking process. This can also be done by means of a translational movement back and forth along the longitudinal axis by pulling out and pushing in the closing element. Mixed rotational-translational pivot movements are also possible by means of suitable kinematics units. In any case, intermediate positions are also possible, for example to open the cooking chamber just a bit for ventilation or cooling after a cooking process.

In order to relieve the user of the task of performing these movements between the fully opened state and the fully closed state, it is also known to use a drive, in particular an electric drive, for this purpose. This is shown, for example, in document US 2023/0084696 A1.

The pivoting movements described above are implemented by means of a motor, in particular, an electric rotationally drivable motor that can transfer its rotational movement by means of a crank to a translational movement along the longitudinal axis, which can then, comparable to the movement of the user's hand, pivot the closing element back and forth or open and closed about its axis of rotation.

The problem with such cooking appliances with a motorized closing element is that the access opening can only be opened and closed by means of the movable closing element by means of the drive or motor. Otherwise, the force applied by the user to open or close the door will also be partially transferred to the non-running motor of the drive, which can lead to failure of the motor gear. Thus, because there is a direct connection between the movable closing element and the motor, force is always introduced into the motor gear when the closing element is moved manually (in case of improper use or de-energized device). Impact loads can lead to failure of the drive gearbox. In addition, the user is always working manually against the motor, which can cause an unpleasant feeling of worrying about whether this could damage or destroy the cooking appliance or it's motor. This also applies to other household appliances.

### BRIEF SUMMARY

The present disclosure addresses the problem of providing a household appliance, preferably a cooking appliance, with a motorized closing element, so that the closing element can nevertheless be moved or operated manually by the user without damaging the motor. At least one additional manual opening and closing in this sequence should be possible. In particular, it can be possible to completely avoid the introduction of forces into the motor of the drive when the movable closing element is moved manually. In particular, it can be possible to move the movable closing element manually when the household appliance is de-energized. In particular, manual and motorized household appliances of the movable closing element should be able to be operated in any sequence. In any case, a simple, space-saving, cost-effective and/or low-maintenance appliance is provided. At least one alternative to the known household appliances of this kind is to be provided.

The present disclosure thus relates to a household appliance with an interior space designed to receive at least one object to be treated through an access opening along the longitudinal axis, with a closing element designed to close and unblock the access opening of the interior space from the front, preferably by pivoting by means of a pivoting element, preferably a hinge, and having a preferably electric motor designed to move the closing element back and forth between a position closing the access opening and a position unblocking the access opening.

The household appliance may, in particular, be a cooking appliance, but may also be another household appliance such as a washing machine, a dryer or the like. In this case, the object to be treated may be laundry to be washed or dried. As a cooking appliance, this may be an oven, an oven with integrated microwave, a microwave itself, a “Dialog” oven, a steam oven, a steamer and the like. In this case, the object to be treated may be a food item, i.e., a food to be cooked.

The household preferably has a motor that is fixedly connected to a clutch disc by means of a motor shaft in order to rotatably drive the clutch disc, wherein the clutch disc is connected to the closing element in a force-transmitting manner by means of a clutch pin, preferably a crank, wherein the clutch disc has a clutch-side guide contour which movably receives a first end of the clutch pin, wherein the clutch-side guide contour of the clutch disc has:
at least one first manual operation guide in which the first end of the clutch pin is received and moved translationally back and forth relative to the non-moving clutch disc if a user manually moves the closing element back and forth between the position closing the access opening and the position unblocking the access opening, and
at least one first motor operation guide in which the first end of the clutch pin is received and is moved rotationally back and forth by the rotating clutch disc if the motor moves the closing element back and forth between the position closing the access opening and the position unblocking the access opening,
wherein the first motor operation guide is formed by one end of the first manual operation guide.

The previously described movement “back and forth” shall be understood as at least the previously explicitly mentioned movement with the closing element closed for opening and then back to the starting position for closing, which can be done either manually or alternatively using the motor. However, “back and forth” may also be understood as the opposite movement sequence from the opened closing element for opening and then for closing again. Preferably, both movement sequences are possible, as will be described in more detail below.

In any case, the combination of first manual operation guide and first motor operation guide of a rotationally drivable clutch disc can enable the clutch pin to execute the previously known motorized movement of the closing element when the clutch disc is driven by a motorized rotating movement by the motor, preferably an electric motor. The first manual operation guide provided parallel thereto can additionally enable the clutch pin, when the clutch disc is stationary, i.e., when the preferably electric motor is non-running, to move alternatively relative to the clutch disc along the first manual operation guide and thus to allow a movement of the closing element using manual actuation by the user, without the manual actuation by the user or without forces from the user being transmitted or being able to act on the motor.

In other words, according to the present disclosure, a specific contour can be followed using a bolt. This contour includes at least one manual operation and one motor operation. Because the force vector is translational for the manual operation and rotational for the motor operation, a distinction can be made between the motor operation and the manual operation.

Thus, according to the present disclosure, a motorized opening and closing of the closing element can be effected by means of the operation of the motor. In addition, however, the user can now also open the closed closing element manually and then close it again without acting on the motor, i.e., without applying any force to the motor. Alternatively, the reverse movement can also be accomplished manually.

Using a crank to transmit force between the clutch disc and the closing element can be a simple way to convert the rotational movement of the motor-driven clutch disc to a translational movement that can lead to the closing element being pivoted open and closed.

The household appliance further has a fixed motor mount with a motor-side guide contour that movably receives a second, opposite, end of the clutch pin, wherein the motor-side guide contour of the motor mount has:
at least one manual operation guide in which the second end of the clutch pin is received and moved at least substantially translationally back and forth relative to the motor mount if a user manually moves the closing element back and forth between the position closing the access opening and the position unblocking the access opening, and
at least one motor operation guide in which the second end of the clutch pin is received and is moved back and forth in an arc by the rotating clutch disc if the motor moves the closing element in a motorized manner back and forth between the position closing the access opening and the position unblocking the access opening,
wherein the manual operation guide and the motor operation guide of the fixed motor mount merge into each other at both ends of their paths.

In this way, a further guide contour that is fixed relative to the clutch disc can be created, which can expand the possibilities of the previously described movement sequence. In particular, this makes it possible that the previously described back-and-forth movements no longer have to be fully executed or completed in order to enable an alternative movement. Rather, each movement can be made and completed in one direction in order to then transition directly into one of the other movements. This can increase operational flexibility.

In other words, in this case, the user may, for example, manually open a closed closing element and then have the latter closed again in a motorized manner, which, as described above, would require the closing element to first be closed again manually in order to assume a starting position for a motorized movement. This is no longer necessary due to the motor-side guide contour of the motor mount.

According to the present disclosure, the manual operation guide of the clutch disc and/or the motor mount extends in a straight line, in particular radially through the axis of the motor shaft. The motor operation guide of the clutch disc and/or the motor mount extends in a semicircle about the axis of the motor shaft.

The present disclosure includes the finding that, in this way, a rotational movement over a distance of 180 degrees can be generated, since the two motor operation guides are each semicircular and thus designed as a semicircle. This reduces the forces required to generate the respective movement and increases the time in which the closing element is moved, compared to a rotationally shorter path of, for example, 90 degrees or 120 degrees.

Furthermore, the principle of a knee lever can be used. This ensures that the force introduction is not linear (as with gears, for example), but instead is greatest in the two end positions, i.e., in the position closing the access opening and in the position unblocking the access opening. As already mentioned, the use of a toggle lever is based on the idea that the most force is required in the two end positions to move the closing element or door. Due to the provided length of the semicircular motor operation guides of 180 degrees each, these operating points and thus the points of movement where the knee lever generates the most force and where the most force is required to move the closing element are located exactly one above the other, so that the maximum available force can be utilized there.

Furthermore, the semicircular motor operation guides each having a180-degree design facilitates the joining and ensures a safer transition of the bolt between the motor operation and the manual operation, thus preventing possible blockage.

A further aspect of the present disclosure can be seen in the fact that the motor operation has a free run in the form of a curved elongated hole. This elongated hole can allow the closing element to fall into the end positions, which can give the user the impression of harmonious, high-quality movement of the closing element.

According to one aspect of the present disclosure, the clutch-side guide contour of the clutch disc and the motor-side guide contour of the motor mount are congruent. This can be one specific possibility for implementation. This can, in particular, simplify or ensure the desired interaction of the two guide contours.

According to a further aspect of the present disclosure, the household appliance further has at least one spring element designed to substantially hold the closing element upon undercutting a tilting point of a movement into the position unblocking the access opening, and further has a control unit which is designed to allow the motor to move the closing element during the movement into the position unblocking the access opening only until the tilting point is reached and then to move the motor back into the previous position.

The two semicircular guide contours allow the control of the drive unit to be changed or designed so that the motor only has to open the closing element until the closing element begins to fall on its own due to its weight, which can be the case at an angle of approximately 15 degrees to 20 degrees relative to the vertical, i.e., starting from the position closing the access opening. The motor can then reverse its movement and return to the previous position so that a new movement sequence can start.

As a result, the motor can be supplied with significantly less current over its lifetime than in the previously described aspects of the present disclosure, which can promote its longevity.

Furthermore, because the closing element only needs to be “nudged open” by the motor and no longer needs to be opened up, cases of improper use caused by a person interfering with the motorized movement sequence of the closing element can be prevented. If, for example, the person were to block the closing element during an opening process after an opening angle of 15 degrees, then no force would be transmitted to the motor, since the closing element would then already be in the free run of the motor operation. This means that starting at this point the person cannot exert any direct force on the motor or gearbox, so that the motor and gearbox can be protected from this.

According to a further aspect of the present disclosure, the household appliance further has at least one spring element that is designed to close the closing element upon exceeding a closing point of a movement into the position closing the access opening, and further has a control unit that is designed to allow the motor to move the closing element during the movement into the position closing the access opening only until the closing point is reached and then to move the motor back into the previous position.

Thus, compared to the previous aspect of the present disclosure, even during closing, the motor can only move the closing element sufficiently far, for example up to 75 degrees but not up to 90 degrees. The final portion of the closing movement of, for example, 15 degrees can then be achieved in that the closing element is pulled by the springs in the hinge, so that a harmonious movement can also be created during closing.

According to a further aspect of the present disclosure, the manual operation guide and the motor operation guide of the motor-side guide contour of the motor mount are separated from one another radially to the motor shaft by means of a separating element of the motor-side guide contour of the motor mount and extend continuously about the separating element, and the first manual operation guide and the first motor operation guide of the clutch-side guide contour of the clutch disc are separated from one another approximately radially to the motor shaft by means of a separating element of the clutch-side guide contour of the clutch disc and extend continuously about the separating element. This separating element may be part of the geometry, but is not absolutely necessary to fulfill the function.

In this way, a separate guidance of the translational and semicircular or arcuate movement can be achieved in that the separating element prevents movement of the clutch pin between the respective manual operation guide and motor operation guide and thus safely guides the clutch pin either in the manual operation guide or in the motor operation guide. The progression of the movement of the clutch pin around the separating element enables the clutch pin to be switched between the manual operation guide and the motor operation guide, but only at the end or at the beginning of the movement and not during the movement. The separating element prevents this.

One aspect is that the path of a manual operation guide, described as being straight and perpendicular to the motor shaft, shall be understood, in particular, to mean that the manual operation guide is aligned parallel to a plane in which the motor shaft lies.

### BRIEF DESCRIPTION OF THE DRAWINGS

An exemplary embodiment of the present disclosure is shown purely schematically in the drawings and will be described in more detail below. In the drawings:

FIG. 1 is a perspective view of an inventive household appliance in the form of a cooking appliance with an opened access opening, viewed obliquely from the front and above;

FIG. 2 is a side view with a partial longitudinal section of or through a connecting kinematics unit with electric motor and clutch disc;

FIG. 3 is a plan view with a partial longitudinal section through the connecting kinematics unit with clutch disc and motor mount;

FIG. 4 is a side view of a clutch disc with clutch-side guide contour;

FIG. 5 is a side view of a corresponding motor mount with motor-side guide contour;

FIG. 6 shows the clutch pin of the connecting kinematics unit with clutch disc and motor mount in the position closing the access opening;

FIG. 7 shows the clutch disc in a rotational movement of a motorized opening into the position unblocking the access opening, starting from the closing position of FIG. 6;

FIG. 8 shows the representation of FIG. 7 with the clutch disc moving into the starting position;

FIG. 9 shows the clutch disc in the position unblocking the access opening as a result of the motorized opening by the electric motor along the motor operation direction of FIGS. 7 and 8;

FIG. 10 shows the clutch disc in a rotational movement of a motorized closing into the position closing the access opening, starting from the unblocking position of FIG. 9;

FIG. 11 shows the representation of FIG. 10 with the clutch disc moving into the starting position;

FIG. 12 shows the clutch disc in the position closing the access opening as a result of the motorized closing by the electric motor along the motor operation direction of FIGS. 10 and 11;

FIG. 13 shows the clutch disc in a translational movement of a manual opening by a person into the position unblocking the access opening, starting from the closing position of FIG. 12;

FIG. 14 shows the clutch disc in the position unblocking the access opening as a result of manual opening by the person along the manual operation direction of FIG. 13; and

FIG. 15 shows the clutch disc in a translational movement of manual closing by a person into the position closing the access opening, starting from the unblocking position of FIG. 14.

### DETAILED DESCRIPTION

The above figures are viewed in Cartesian coordinates. There is a longitudinal axis X, which can also be referred to as depth X or length X. A transverse axis Y, which can also be referred to as width Y, extends perpendicular to the longitudinal axis X. A vertical axis Z, which can also be called height Z and corresponds to the direction of gravity, extends perpendicular to both the longitudinal axis X and the transverse axis Y. The longitudinal axis X and the transverse axis Y together form the horizontal X, Y, which can also be called the horizontal plane X, Y.

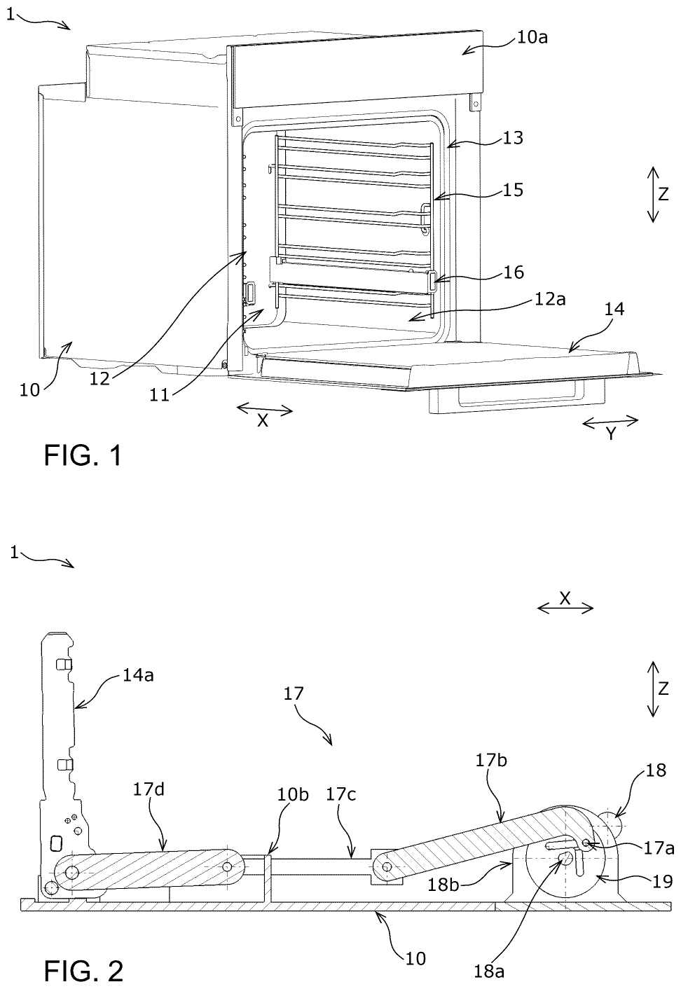

FIG. 1 shows a perspective view of an inventive household appliance 1 in the form of a cooking appliance 1 with opened access opening 13 obliquely from above and the front.

An inventive household appliance 1 or cooking appliance 1 is considered using the example of an oven 1. The oven 1 has an exterior housing 10, which can also be referred to as the outer housing 10 and essentially encloses the oven 1 or closes it off to the outside. The exterior housing 10 is closed along the longitudinal axis X towards the front, i.e., towards the user, in the upper area with a panel 10a. An interior housing 11, which can also be referred to as the inner housing 11, is arranged inside the exterior housing 10. The interior housing 11 terminates with the exterior housing 10 along the longitudinal axis X to the rear, along the vertical axis Z downwards and upwards, and along the transverse axis Y on both sides, so that an intermediate space is formed between the exterior housing 10 and in the interior housing 11, and can also be referred to as the housing space. This intermediate space represents the interior of the oven 1.

The interior housing 11 further essentially encloses an interior space 12 in which a cooking process can be carried out. To this end, corresponding elements for heating the interior space 12 (not shown) are arranged in the intermediate space or in the cooking chamber 12. Accordingly, the interior space 12 can also be referred to as the cooking chamber 12.

The cooking chamber 12 is accessible to the user from the front along the longitudinal axis X through an access opening 13 disposed below the panel 10a. The access opening 13 can be closed and opened by means of a closing element 14 in the form of an appliance door 14. To this end, the appliance door 14 is connected to the exterior housing 10 of the oven 1 by means of at least one hinge (not shown) so as to be pivotable upwards about the transverse axis Y, so that the appliance door 14 can be pivoted upwards away from the user in order to close the access opening 13 and can be pivoted downwards towards the user in order to unblock the access opening 13 and to be able to access the cooking chamber 12, see FIG. 1.

On each side along the transverse axis Y the cooking chamber 12 has a side wall 12a, and a removable receiving frame 15 is arranged on each of these. A telescoping rail 16 is removably attached to each receiving frame 15 at the same height along the vertical axis Z, and together they form a pair of telescoping rails 16. The telescoping rails 16 are each formed in three parts along the longitudinal axis X (not shown), so that a front rail element is connected to a rear rail element of the telescoping rail 16 by means of a center rail element, wherein the rear rail element is held fixedly and removably on the respective receiving frame 15.

A cooking vessel such as a baking sheet (not shown) can be placed by the user on the pair of telescoping rails 16 or their front rail elements in order to be pushed into the cooking chamber 12 along the longitudinal axis X and pulled out of the cooking chamber 12. This can make it easier for the user to insert the baking sheet into the cooking chamber 12 and to remove it from the cooking chamber 12.

FIG. 2 shows a side view with partial longitudinal section of or through a connecting kinematics unit 17 with electric motor 18 and clutch disc 19.

The connecting kinematics unit 17 with electric motor 18 and clutch disc 19 is arranged laterally in the intermediate space of the oven 1 and can be used by the user to operate the appliance door 14 as a closing element 14 in a motorized manner, so that the user does not have to do this himself. The motorized movement, in particular for opening the closed appliance door 14 and then again for closing the opened appliance door 14, see FIG. 1, can be carried out by the user, in particular by actuating a corresponding operating element (not shown), which may be arranged on the outside of the appliance door 14 (not shown) and/or on the panel 10a (not shown).

To guide the connecting kinematics unit 17, the exterior housing 10 has an internal guide element 10b oriented upwards along the vertical direction Z and having a through-opening (not shown) along the longitudinal axis X. Facing the user along the longitudinal axis X, a closing element connector 14a, also called a strut 14a, is pivotably arranged on the front edge of the exterior housing 10. The closing element 14 or the appliance door 14 (not shown, see FIG. 1) is fixedly mounted on the closing element connector 14a and is thus pivotable.

The aforementioned electric motor 18 is fixedly arranged, by means of a motor mount 18b, in the rear area along the longitudinal axis X above the exterior housing 10 or its underside (not identified). On one side, the motor mount 18b is a disc which is fixedly arranged on the underside of the exterior housing 10 in the intermediate space and has a through-opening (not identified) through which a motor shaft 18a projects. The electric motor 18 is fixedly arranged on the one side of the disc-like motor mount 18b so that the rotor (not shown) of the electric motor 18 can drive the motor shaft 18a, which projects from the electric motor 18 through the through-opening of the disc-like motor mount 18b to the opposing side thereof. There, the aforementioned clutch disc 19 is fixedly arranged on the motor shaft 18a, so that the clutch disc 19 can be rotationally driven by the electric motor 18.

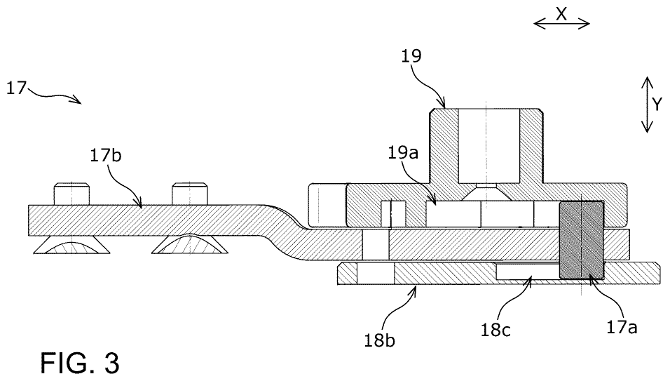

The side of the clutch disc 19 facing away from the disc-like motor mount 18b has a clutch-side guide contour 19a, which will be described in more detail with reference to FIGS. 3 to 11. A first end of a clutch pin 17a engages in the clutch-side guide contour 19a, so that there is a positive connection between the first end of the clutch pin 17a and the clutch disc 19, which can transmit the force from the electric motor 18 to the clutch pin 17a.

The clutch pin 17a is rotatably mounted in a corresponding through-opening (not identified) of one end of a crank 17b, which is rotatably connected at the opposite end to a guide rod 17c that is translationally movable along the longitudinal axis X and that is guided by the through-opening of the aforementioned guide element 10b of the exterior housing 10. The opposite end of the guide rod 17c is connected to the closing element connector 14a by means of a connecting element 17d for pivoting it back and forth as already mentioned above.

If the electric motor 18 is now operated and thereby—as previously known—its rotational movement is transmitted to the closing element connector 14a, the appliance door 14 can, as already mentioned above, be moved back and forth in a motorized manner between a position closing the access opening 13 and a position unblocking the access opening 13. According to the present disclosure, the rotational movement of the electric motor 18 can be converted to a translational movement by means of the clutch disc 19, the clutch pin 17a and the crank 17b, which can pivot the appliance door 14 open and closed.

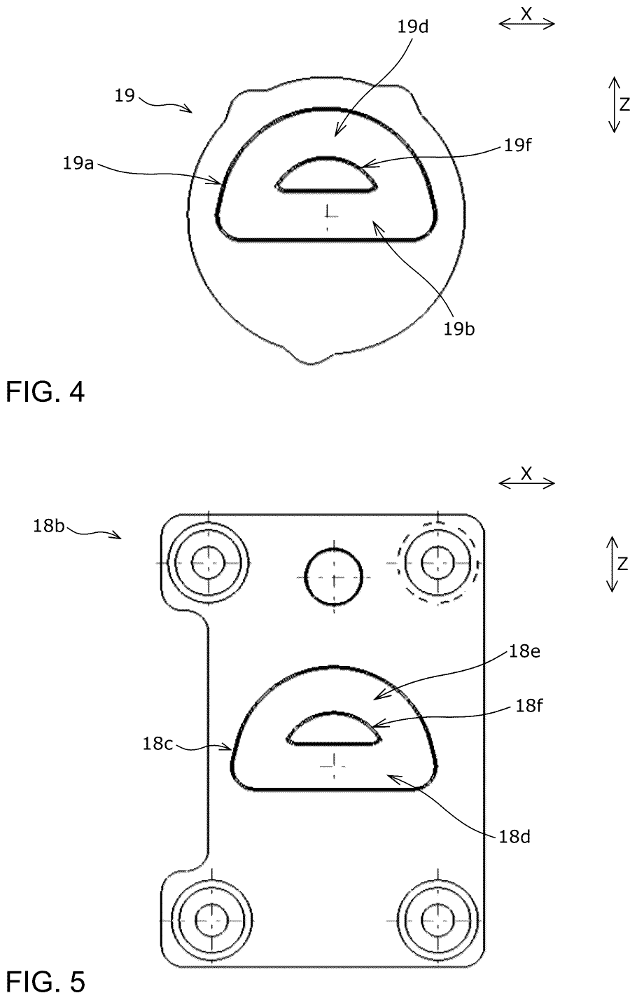

Further provided according to the present disclosure is a manual operation guide 19b of the clutch disc 19 (as a component of the clutch-side guide contour 19a) see, e.g., FIGS. 3 and 4. The first end of the clutch pin 17a is always movably received or guided by the clutch-side guide contour 19a, so that the rotational movement of the clutch disc 19 can be transmitted to the clutch pin 17a if the clutch pin 17a is disposed in the motor operation guide 19d.

At the same time, however, according to the present disclosure, it is also possible for the clutch pin 17a to be moved translationally along the manual operation guide 19b of the stationary, i.e., non-motor-driven, clutch disc 19 if the user pivots the appliance door 14 open and closed by hand. In this case, the force of the manual movement by the user is not transferred to the non-running electric motor 18, so that the motor 18 cannot be damaged by the manual movements of the user.

FIG. 3 shows a plan view with a partial longitudinal section through the connecting kinematics unit 17 with clutch disc 19 and motor mount 18b.

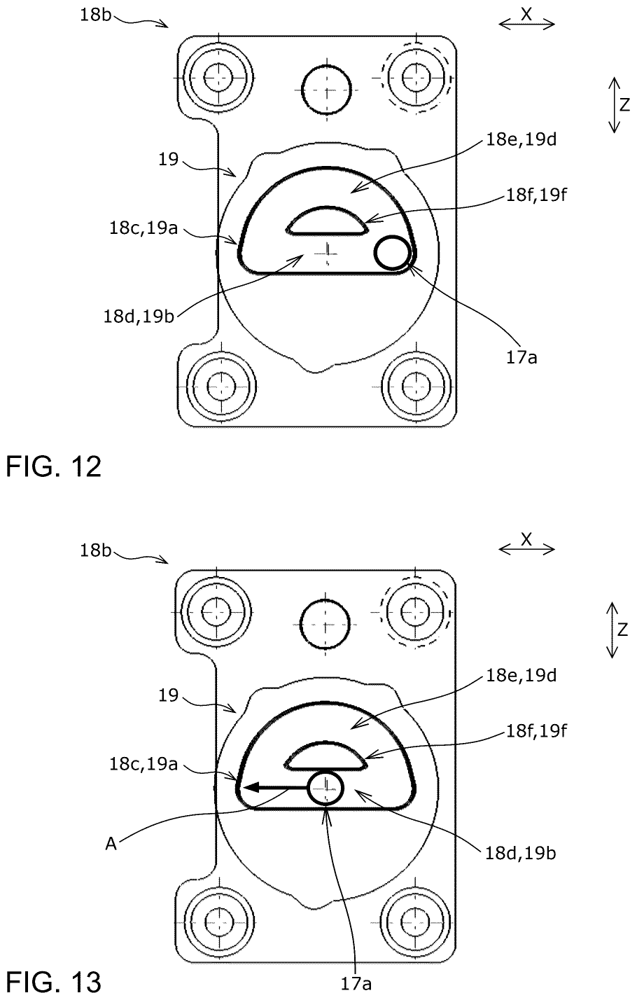

The motor guide 18b is extended by a second disc, so that the two discs (not identified) of the motor guide 18b accommodate the clutch disc 19 and the end of the crank 17b with the clutch pin 17a between them (FIG. 3 shows only the disc of the motor guide 18b with the motor-side guide contour 18c). The clutch pin 17a is designed extended so that a second end of the clutch pin 17a that is opposite of the first end engages in the motor-side guide contour 18c of the second disc of the motor guide 18b, see FIG. 12, and can be guided there.

FIG. 4 is a side view of a clutch disc 19 with clutch-side guide contour 19a. FIG. 5 shows a side view of a corresponding motor mount 18b with motor-side guide contour 18c.

The clutch-side guide contour 19a of the clutch disc 19 has the first manual operation guide 19b, which extends radially through the axis of the motor shaft 18a, and the first motor operation guide 19d, which extends in a semicircle about the axis of the motor shaft 18a. The first manual operation guide 19b and the first motor operation guide 19d of the clutch-side guide contour 19a of the clutch disc 19 merge into one another.

The motor-side guide contour 18c of the motor mount 18b has the manual operation guide 18d, which extends radially through the axis of the motor shaft 18a, and the motor operation guide 18e, which extends in a semicircle around the axis of the motor shaft 18a. The manual operation guide 18d and the motor operation guide 18e of the motor-side guide contour 18c of the motor mount 18b merge into one another.

The clutch-side guide contour 19a of the clutch disc 19 and the motor-side guide contour 18c of the motor mount 18b are designed to be congruent.

The manual operation guide 18d and the motor operation guide 18e of the motor-side guide contour 18c of the motor mount 18b are separated from each other radially to the motor shaft 18a by means of a separating element 18f of the motor-side guide contour 18c of the motor mount 18b and extend continuously about the separating element 18f. Likewise, the first manual operation guide 19b and the first motor operation guide 19d of the clutch-side guide contour 19a of the clutch disc 19 are separated from each other radially to the motor shaft 18a by means of a separating element 19f of the clutch-side guide contour 19a of the clutch disc 19 and extend continuously about the separating element 19f.

Furthermore, the household appliance has a spring element designed to substantially hold the closing element 14 in the position unblocking the access opening 13 upon undercutting a tilting point of a movement. In addition, the household appliance has a control unit (not shown) designed to allow the motor 18 to move the closing element 14 during the movement into the position unblocking the access opening 13 only until the tilting point is reached and then to move the motor 18 back to the previous position.

Likewise, the household appliance has a spring element designed to close the closing element 14 once a closing point of a movement into the position closing the access opening 13 is exceeded, and the control unit is further designed to allow the motor 18 to move the closing element 14 during the movement into the position closing the access opening 13 only until the closing point is reached and then to move the motor 18 back to the previous position.

The motorized as well as the manual opening and closing of the closing element 14 of the household appliance 1 can now be carried out as follows:

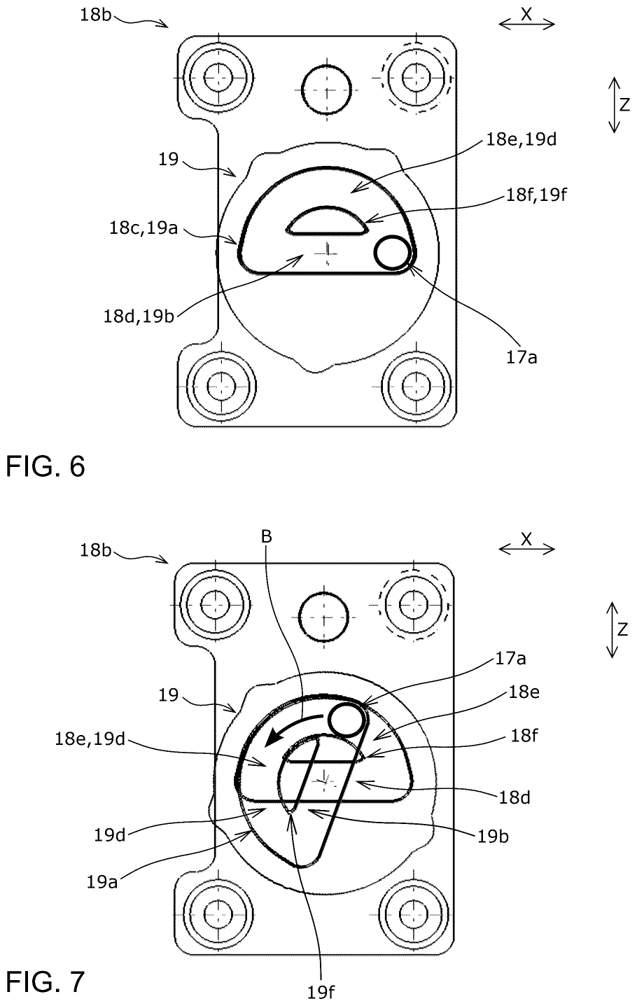

FIG. 6 shows the clutch pin 17a of the connecting kinematics unit 17 with clutch disc 19 and motor mount 18b in the position closing the access opening 13.

The motor-side guide contour 18c and the clutch-side guide contour 19a lie congruently over one another. The clutch pin 17a is arranged along the longitudinal axis X to the right or, from the perspective of the connection kinematics unit 17, to the rear. The closing element 14 is thus in the position closing the access opening 13.

FIG. 7 shows the clutch disc 19 in a rotational movement B of a motorized opening into the position unblocking the access opening 14, starting from the closing position of FIG. 6.

Thus, the motor 18 is now operated by the control unit in a counterclockwise direction, i.e., rotating to the left as shown in FIG. 7, so that the clutch disc 19 is moved in a corresponding rotational manner. The clutch disc 19 or its clutch-side guide contour 19a causes the clutch pin 17a to move along the motor-side guide contour 18c, so that the clutch pin 17a is moved in a semicircular manner in the motor operation direction B in the overlapping or overlaying motor operation guides 18e of the motor mount 18b and motor operation guide 19d of the clutch disc 19.

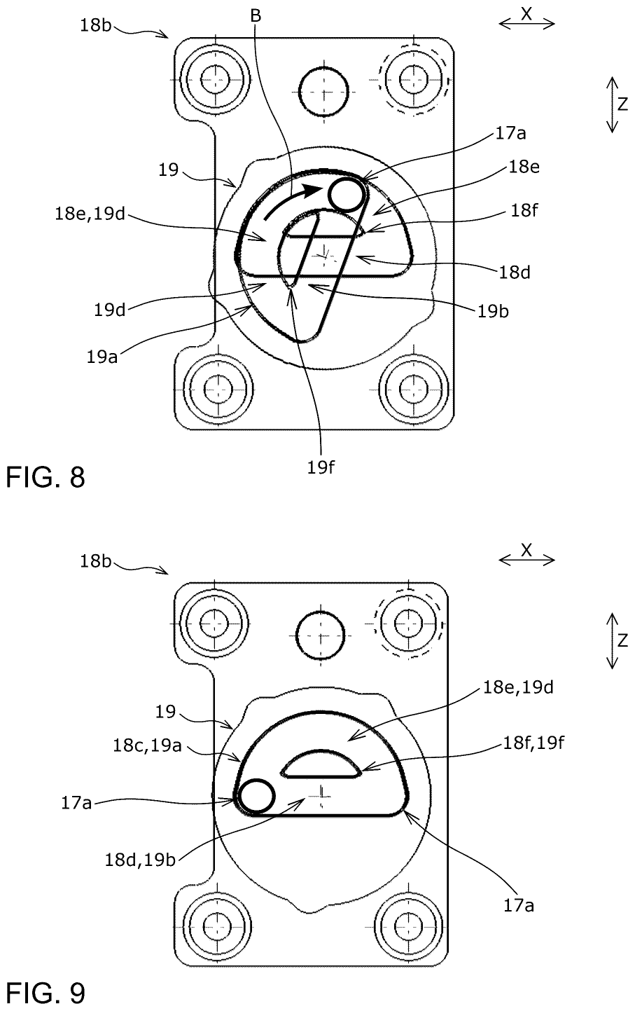

FIG. 8 shows the illustration from FIG. 7 with the clutch disc 19 moving into the starting position.

If the movement of the clutch pin 17a according to FIG. 7 falls below the previously mentioned tilting point, which is at approximately 15 degrees to 20 degrees of the semicircular movement, the force of gravity is sufficient to open the closing element further and move it completely into the position unblocking the access opening 14. Due to the spring element, this is damped such that a uniform movement is created. Accordingly, however, the remaining movement can be carried out without the motor 18, so that the motor 18 is moved back to the previous position as the starting position in the motor operation direction B as soon as the tilting point is reached.

FIG. 9 shows the clutch disc 19 in the position unblocking the access opening 14 as a result of the motorized opening of the electric motor 18 along the motor operation direction B of FIGS. 7 and 8. Now the access opening 14 is open and the user can access the interior space 12 of the household appliance 1.

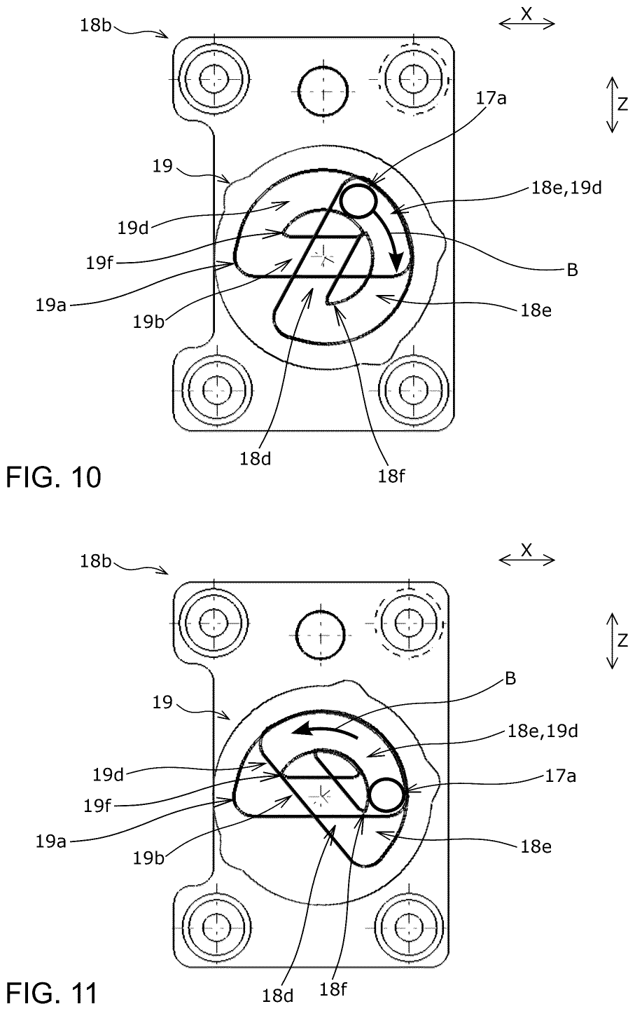

FIG. 10 shows the clutch disc 19 in a rotational movement of a motorized closing into the position closing the access opening starting from the unblocking position of FIG. 9.

Now the clutch disc 19 is rotated by the motor 18 in the motor operation direction B, rotating to the right or clockwise, so that the clutch pin 17a is again moved in a semicircular manner in the overlapping or overlaying motor operation guides 18e of the motor mount 18b and motor operation guide 19d of the clutch disc 19.

FIG. 11 shows the illustration from FIG. 10 with the clutch disc 19 moving into the starting position. In this case too, the motor 18 can move the clutch disc 19 back to the previous starting position if the remaining movement can be carried out without the motor 18. This occurs here when a closing point is exceeded at approximately 75 degrees of the movement already made, i.e., with only approximately 15 degrees of movement remaining, since then a spring element can also act and pull the closing element into the position that closes the access opening.

FIG. 12 shows the clutch disc 19 in the position closing the access opening 14 as a result of the motorized closing of the electric motor 18 along the motor operation direction B of FIGS. 10 and 11. The access opening 14 is then closed again.

FIG. 13 shows the clutch disc 19 in a translational movement of a manual opening by a person into the position unblocking the access opening 14, starting from the closing position of FIG. 12. In this case, the user manually pulls the closing element 14 towards himself or pivots the closing element 14 towards himself, so that the connecting kinematics unit 17 is moved substantially along the longitudinal axis X. As a result, the clutch pin 17a is also moved along the longitudinal axis X, which is possible purely translationally in a manual operation direction A due to the straight manual operation guide 18d of the motor mount 18b and the congruent straight manual operation guide 19b of the clutch disc 19.

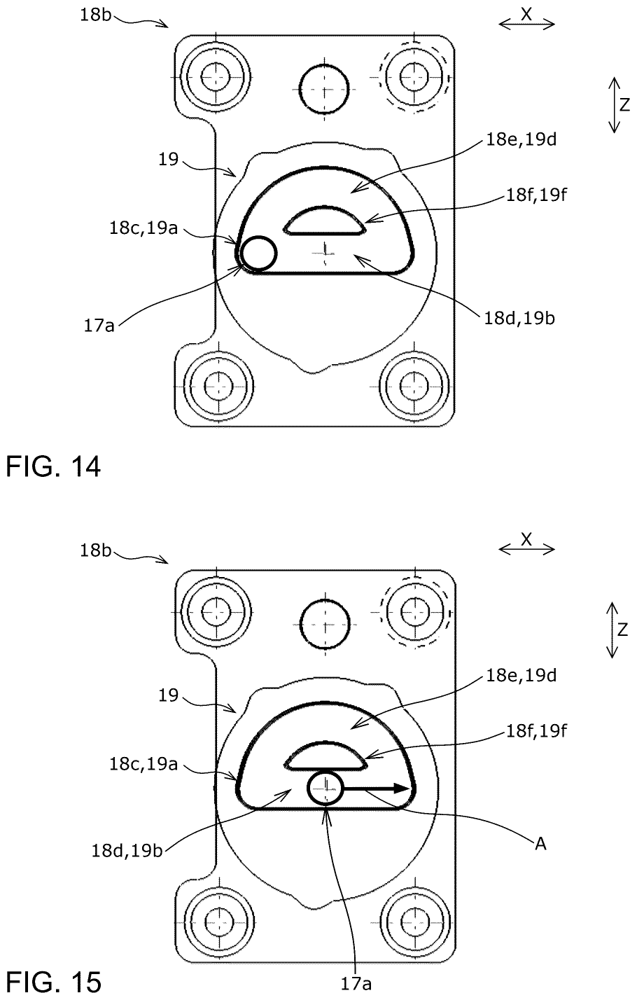

FIG. 14 shows the clutch disc 19 in the position unblocking the access opening 14 as a result of the manual opening by the person along the manual operation direction A of FIG. 13. Corresponding to the previously described translational movement, the clutch pin 17a reaches the other end of the congruent manual operation guide 18d of the motor mount 18b and the straight manual operation guide 19b of the clutch disc 19.

FIG. 15 shows the clutch disc 19 in a translational movement of a manual closing by a person into the position closing the access opening 14 starting from the unblocking position of FIG. 14. The previously described process can also be carried out in reverse by the person in order to manually close the access opening 14 again.

Once the clutch pin 17a has reached one or the other end of the translational movement or the rotational movement, the next movement can be carried out both manually as well as in a motorized manner, so that any combination of movements as previously described is possible.

### LIST OF REFERENCE SIGNS (PART OF THE DESCRIPTION)

A Manual operation direction
B Motor operation direction
x Longitudinal axis; depth; length
Y Transverse axis; width
Z Vertical axis; height
X, Y Horizontal; horizontal plane
1 Household appliance; cooking appliance; oven
10 Exterior housing; outer housing
10a Panel
10b Guide element
11 Interior housing; inner housing
12 Interior space; cooking chamber
12a Side walls of the cooking chamber 12
13 Access opening
14 Closing element; appliance door
14a Closing element connector; strut
15 Support frame
16 Telescoping rails
17 Connection kinematics unit
17a Clutch pin
17b Crank
17c Guide rod
17d Connecting element
18 (Electric) motor
18a Motor shaft
18b Motor mount
18c Motor-side guide contour
18d Manual operation guide of the motor mount 18b
18e Motor operation guide of the motor mount 18b
18f Separating element or brake of the motor-side guide contour 18c
19 Clutch disc
19a Clutch-side guide contour
19b Manual operation guide of the clutch disc 19
19d Motor operation guide of the clutch disc 19
19f Separating element or brake of the clutch-side guide contour 19a

1. A household appliance comprising:
an interior space configured to receive at least one object to be treated through an access opening along a longitudinal axis;
a closing element configured to close and unblock the access opening of the interior space from a front side; and
a motor configured to move the closing element back and forth between a closed position closing the access opening and an open position unblocking the access opening;
wherein the motor is fixedly connected to a clutch disc by way of a motor shaft for rotatably driving the clutch disc;
wherein the clutch disc is connected to the closing element in a force-transmitting manner by way of a clutch pin;
wherein the clutch disc has a clutch-side guide contour which movably receives a first end of the clutch pin;
wherein the clutch-side guide contour of the clutch disc has,
at least one manual operation guide in which the first end of the clutch pin is received and moved translationally back and forth relative to the non-moving clutch disc when a user manually moves the closing element back and forth between the closed position closing the access opening and the open position unblocking the access opening, and
at least one motor operation guide in which the first end of the clutch pin is received and is moved rotationally back and forth by the rotating clutch disc when the motor moves the closing element back and forth between the closed position closing the access opening and the open position unblocking the access opening,
wherein the motor operation guide is formed by one end of the manual operation guide.

2. The household appliance according to claim 1,
wherein the first motor operation guide extends in a semicircle about the axis of the motor shaft, and
further comprising a fixed motor mount having a motor-side guide contour that movably receives a second, opposite, end of the clutch pin.

3. The household appliance according to claim 1,
wherein the motor-side guide contour of the motor mount has,
at least one manual operation guide in which the second end of the clutch pin is received and moved at least substantially translationally back and forth relative to the motor mount if a user manually moves the closing element back and forth between the closed position closing the access opening and the open position unblocking the access opening, and
at least one motor operation guide in which the second end of the clutch pin is received and moved back and forth in an arc by the rotating clutch disc when the motor moves the closing element in a motorized manner back and forth between the closed position closing the access opening and the open position unblocking the access opening.

4. The household appliance according to claim 1,
wherein the manual operation guide and the motor operation guide of the fixed motor mount transition into one another at both ends of their paths
and/or
wherein the motor operation guide extends in a semicircle about the axis of the motor shaft.

5. The household appliance according to claim 1,
wherein the clutch-side guide contour of the clutch disc and the motor-side guide contour of the motor mount are congruent.

6. The household appliance according to claim 1,
further comprising at least one spring element configured to substantially hold the closing element in the closed position unblocking the access opening upon undercutting a tilting point of a movement.

7. The household appliance according to claim 1,
further comprising a control unit configured to allow the motor to move the closing element during the movement into the closed position unblocking the access opening only until the tilting point is reached and then to move the motor back into a previous position.

8. The household appliance according to claim 1,
further comprising at least one spring element configured to close the closing element into the closed position closing the access opening upon exceeding a closing point of a movement.

9. The household appliance according to claim 1,
further comprising a control unit configured to allow the motor to move the closing element during the movement into the closed position closing the access opening only until a closing point is reached and then to move the motor back into a previous position.

10. The household appliance according to claim 1,
wherein at least one of the manual operation guides extends radially through the axis of the motor shaft.

11. The household appliance according to claim 1,
wherein the manual operation guide and the motor operation guide of the motor-side guide contour of the motor mount are separated from one another radially to the motor shaft by means of a separating element of the motor-side guide contour of the motor mount and extend continuously about the separating element.

12. The household appliance according to claim 1,
wherein the first manual operation guide and the first motor operation guide of the clutch-side guide contour of the clutch disc are separated from one another radially to the motor shaft by means of a separating element of the clutch-side guide contour of the clutch disc and extend continuously about the separating element.

13. The household appliance according to claim 1,
wherein the household appliance is a cooking appliance.

14. The household appliance according to claim 1,
wherein the closing element is pivotally connected to the household appliance via a hinge.

15. The household appliance according to claim 1,
wherein the motor is an electric motor.

16. The household appliance according to claim 1,
wherein the clutch disc is connected to the closing element via a crank.
